(19) United States
(12) Patent Application Publication
(10) Pub. No.: US 2020/0285000 A1
(43) Pub. Date: Sep. 10, 2020

(54) BIFURCATED HOUSING FOR SECURING ONE OR MORE FIBER OPTIC ADAPTER ASSEMBLIES THEREIN

(71) Applicant: Senko Advanced Components, Inc, Marlborough, MA (US)

(72) Inventors: Jimmy CHANG, Worcester, MA (US); Takuya NINOMIYA, Natick, MA (US); Kazuyoshi TAKANO, Tokyo (JP)

(73) Assignee: Senko Advanced Components, Inc, Marlborough, MA (US)

(21) Appl. No.: 16/810,526

(22) Filed: Mar. 5, 2020

Related U.S. Application Data
(60) Provisional application No. 62/814,098, filed on Mar. 5, 2019.

(51) Int. Cl. G02B 6/38

(52) U.S. Cl. CPC G02B 6/3897; G02B 6/3825

(57) ABSTRACT

A bifurcated housing having opposing body portions that when mated stack one or more adapters. The stacked adapters may be different adapter types. A panel clip secures the bifurcated housing within a panel. The adapter types may be stacked vertical or horizontal depending on the panel configuration or network layout. The body portions form an outer housing with opposing sidewalls perpendicular to the outer housing. The sidewalls have a recess or securing clip that when the two body portions are mated, the one or more adapters stacked are secured therein.

### RELATED APPLICATIONS

This application claims priority to U.S. Provisional patent application 62/814,098 filed on Mar. 5, 2019 titled “Bifurcated Housing for Securing One or More Receptacles Therein”, which is fully incorporated into this application.

### FIELD OF THE INVENTION

The described technology generally relates to components for connecting data transmission elements and, more specifically, to adapters configured to connect different types of fiber optic connectors and connector assemblies configured to facilitate optimized performance of a communication network formed with a grouping of adapters securing within a bifurcated mounting plate housing, the adapters interconnect a plural of fiber optic connectors, transceivers or splitters.

### BACKGROUND

Fiber optics have become the standard cabling medium used by data centers to meet the growing needs for data volume, transmission speeds, and low losses. An optical fiber connector is a mechanical device disposed at an end of an optical fiber that acts as a connector of optical paths, for example, when optical fibers are joined together. An optical fiber connector may be coupled with an adapter to connect an optical fiber cable to other optical fiber cables or devices. An adapter may generally include a housing having at least one port that is configured to receive and hold a connector to facilitate the optical connection of one connector to another connector or device. For example, an LC adapter is typically configured to receive one or more standard sized LC connectors. Other adapters include MPO or multi-fiber push-on, push-off connectors, SC adapter to receive and secure a standard connector, and Senko nano-adapters to hold a Senko data center connector. The Senko nano connector can be configured with a mechanical transfer ferrule or two single optical fiber ferrules.

The different type of adapters are positioned horizontally or vertically, and the assembly is secured to a panel with a metal clip positioned about the adapter housing. Prior art adapter assembly are configured to accept one type of fiber optic connector such as MPO, LC or SC connector as in known in the art. Two areas of improvement are possible. First, removing the outer metal clip when positioning one or more adapters vertically or horizontally. Next, adapters can have one or more ports, and but come in single, duplex or quad, so valuable space is lost when a first adapter is needed for a LC connector and the second adapter is needed for a SC connector. Here placing two dissimilar adapters within the bifurcated housing can result in a space savings, as discussed above, but also can allow the design engineer to configure the panel space to accommodate the needs of the interconnections of the network fiber optic connectors. This can also reduce crossing of optical fibers, which can lead to damage of the fiber optic connector or increase signal loss due to insertion when the pull strength of the optical fiber is exceeded due to increased entangling of the optical fibers.

Accordingly, there is a need for an adapter capable of being position adapters of the same type or dissimilar to reduce space and improve network layout.

### SUMMARY

This disclosure is not limited to the particular systems, devices and methods described, as these may vary. The terminology used in the description is for the purpose of describing the particular versions or embodiments only, and is not intended to limit the scope.

According to the present invention, a bifurcated housing with a first body portion and a second body portion are secured together to form a cavity that is configured to accept one or more prior art adapters. The body portions each have an outer housing wall with opposing sidewalls. The sidewalls are formed at substantially a ninety (90) degree angle or substantially perpendicular to the outer housing wall of each body portion. Each sidewall is configured with at least one recess or at least one securing clip, and a panel mounting clip on at least of the body portion sidewalls. The use of the panel clip is described above. The opposing body portions are mated together with when the securing clip is received within the recess. The dimensions of the body portion is sized to accommodate stacking of the adatpers and the mixed adapter types. The bifurcated housing may accommodate two or more stacked adapters of the same type. Or two or more stacked adapters of the different types. The adapters may be stacked vertical or horizontal.

### BRIEF DESCRIPTION OF THE DRAWINGS

The above and other objects of the present invention will become more readily apparent from the following detailed description taken in connection with the accompanying drawings.

FIG. 1 depicts a perspective view of a prior art adapter deploying the present invention;

FIG. 2 is a perspective view of a pair of prior art adapters vertically stack deploying the present invention;

FIG. 3 is an end view of FIG. 1;

FIG. 4 is a cross section side view of FIG. 1;

FIG. 5 is a cross section side view of FIG. 2;

FIG. 6 is a side view of a first body portion of the bifurcated mounting panel;

FIG. 7 is an exploded view of the first body portion and a second body portion depicting assembly with a prior art adapter;

FIG. 8 is an exploded view of the first body portion and the second body portion depicting a first configuration of vertical stacked prior art adapters;

FIG. 9 depicts FIG. 8 configuration of stacking a second type of prior art adapter;

FIG. 10 depicts FIG. 8 configuration of stacking a third type of prior art adapter;

FIG. 11 depicts FIG. 8 configuration of stacking a fourth type of prior at adapter;

FIG. 12 depicts FIG. 8 configuration of stacking a fifth type of prior art adapter;

FIG. 13 depicts FIG. 8 configuration stacking both vertical and horizontal at prior art adapter;

FIG. 14 depicts horizontal stacking of a three or more prior art adapters deploying the present invention;

FIG. 15 depicts the horizontal staking of two or more dissimilar prior art adapters deploying the present invention;

FIG. 16A depicts an exploded view of a prior art fiber optic connector and adapter system;

FIG. 16B depicts an exploded view of a second prior art fiber optic and connector and adapter system, and

FIG. 16C depicts an exploded view of a third prior art fiber optic connector and adapter system.

### DETAILED DESCRIPTION

The described technology generally relates to stacking fiber optic adapters and fiber optic connectors configured to be coupled thereto. In present invention, the stacked adapters are configured to occupy less space, for example, than conventional adapters, while facilitating and optimizing network configuration.

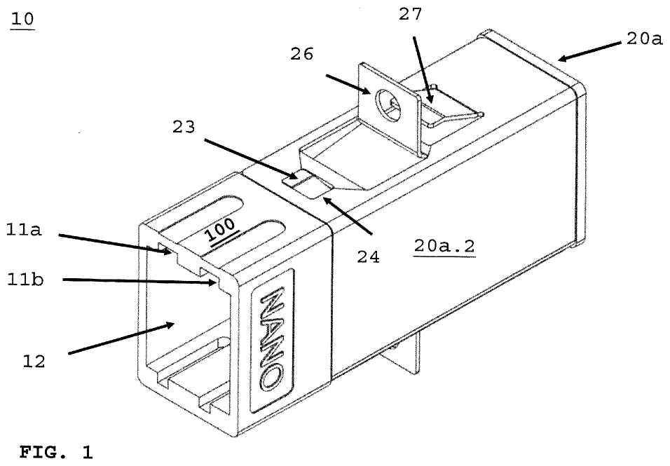

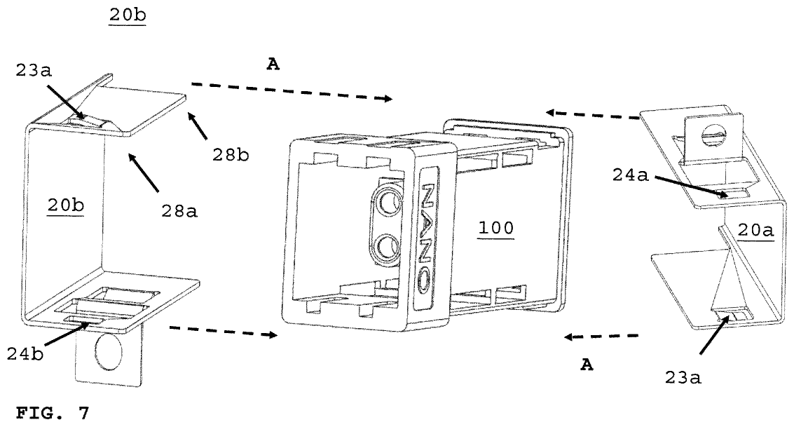

FIG. 1 depicts bifurcated housing (20a, 20b) (refer to FIG. 7) secured about a prior art SN nano adapter (100). Assembly bifurcated housing with at least one prior art adapter secured therein is depicted in FIG. 1, called bifurcated housing assembly (10). FIG. 17A and FIG. 17B depict a SN nano fiber optic connector being inserted into SN nano adapter (100). First body portion (20a) further comprises outer housing wall (20a.2), panel clip (26) with retention tab (27) and recess (24) with securing clip (23) therein. Securing clip (23) is received from second body portion (20b). Proximal end of adapter (100) has port (12) with guide rails (11a, 11 b) that receive and align the fiber optic connector within the port.

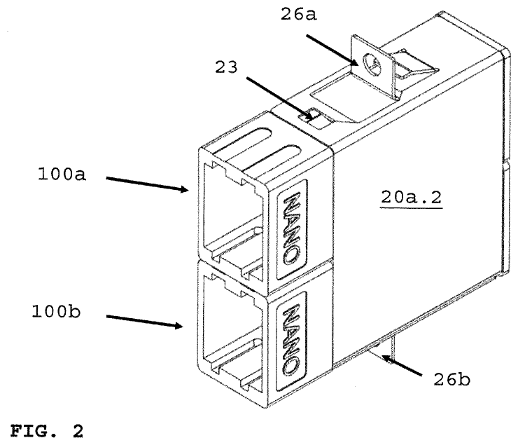

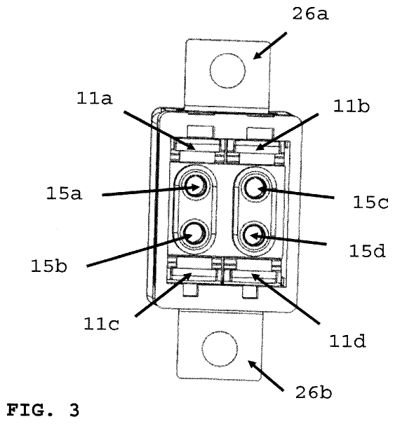

FIG. 2 depicts vertical stacked nano adapters (100a, 100b) secured with bifurcated housing formed by opposing body portions (20a, 20b). Panel clip (26a, 26b) are on opposite side walls. The clips are used to secure the assembly to a panel. FIG. 3 depicts a front perspective view of FIG. 2. Alignment sleeve holders (15a-15d) secure a corresponding ferrule (38a, 38b) (refer to FIG. 17B) as shown in the prior art. The fiber optic connector is aligned within the adapter port using the guide rails (11a, 11c) for the left hand side fiber optic connector and the guide rails (11b, 11d) for the right hand side fiber optic connector. Opposing panel clip (26a, 26b) are shown substantially opposite one another.

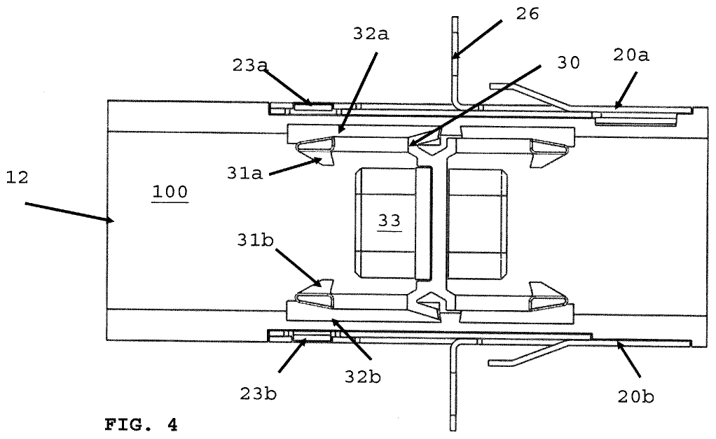

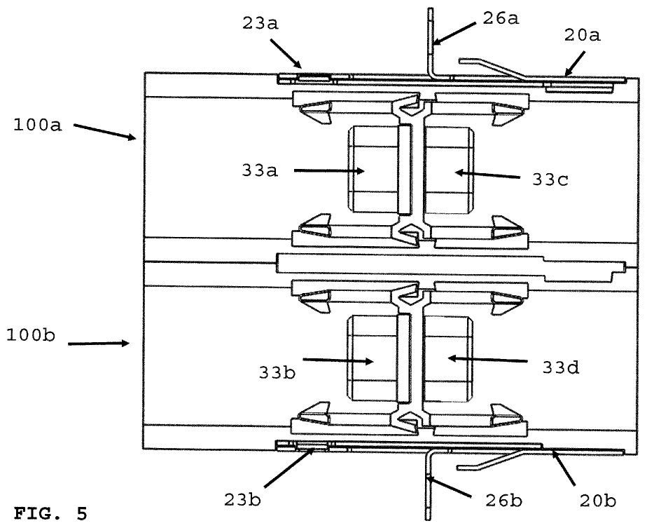

FIG. 4 depicts a cross-section view of FIG. 1. Adapter (100), alignment sleeve holder (33) has a pair of opposing connector latch (31a, 31b). The connector latch secure the fiber optic connector within the adapter port when the ferrule is fully inserted into the alignment sleeve holder. The alignment sleeve holder and opposing connector latches are secured within the adapter port by opposing adapter latch (30). When a connector is inserted into port (12), connector latches (31a, 31b) are received into recess (32a, 32b) respectively and the latches relax in a recess on the connector outer housing thereby securing the connector with the port. The bifurcated housing body portions (20a, 20b) are secured together by securing clips (23a, 23b). FIG. 5 is a cross-section of FIG. 2 illustrating opposing body portions (20a, 20b) securing together stacked adapters (100a, 100b). The body portions form the bifurcated housing with securing clips (23a, 23b) received in a corresponding recess (24) of the opposing body portion as shown in FIG. 7. FIG. 5 further shows a plural of alignment sleeve holders and connector latches to hold fiber optic connectors within the adapter ports.

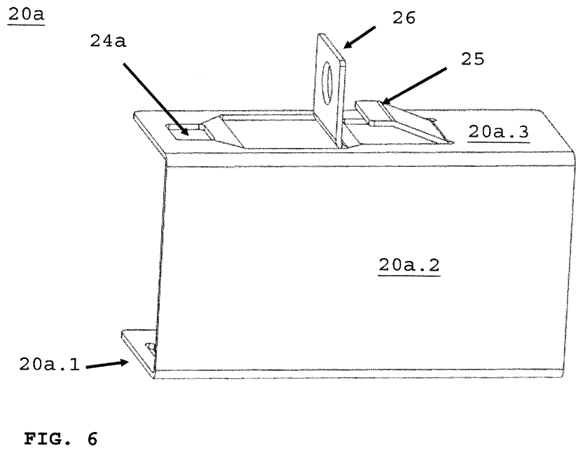

FIG. 6 depicts a body portion, which can be the first body portion or the second body portion. FIG. 6 is selected to describe first body portion (20a) comprising recess (24a) configured to accept securing clip (23) form as part of a sidewall of the second, opposing body portion. First body portion (20a) further comprise panel clip (26) and retention tab (25) formed as part of first sidewall (20a.3). Opposing second sidewall (20a.1) has securing clip (23) that mates and secures with opposing sidewall recess of the second body portion when forming the bifurcated housing. The opposing sidewalls are connected by outer housing wall (20a.2), and the sidewalls are generally perpendicular to the outer housing wall. The outer housing wall is sized to cover the outer dimension of the stacked adapters.

FIG. 7 depicts assembling first body portion (20a) to second body portion (20b) to form a bifurcated housing, and this housing secures adapter (100). Assembly occurs in the direction of the arrows. When assembled securing clip (23a) is received in recess (24b) and likewise securing clip (23b) is received in recess (24a). Also first body portion (20a) rotated one hundred and eighty degrees (180) has the same structure as second body portion (20b). Each sidewall has first end (28a) and second end (28b). The first end is the proximal end and the second end is the distal end.

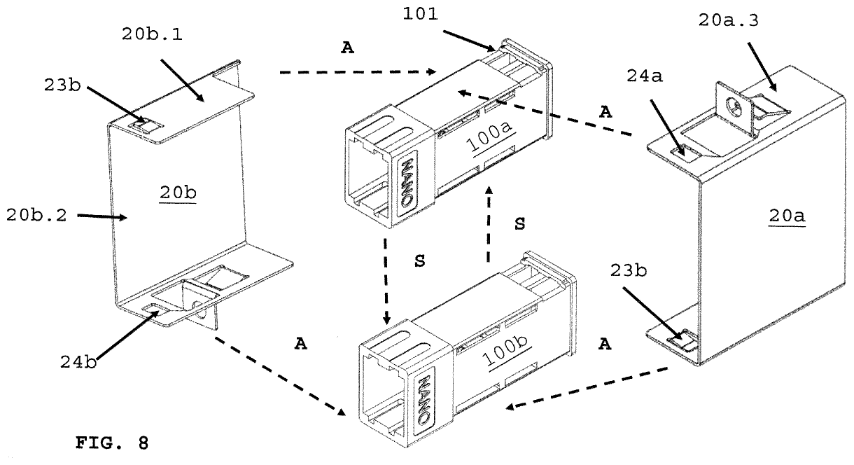

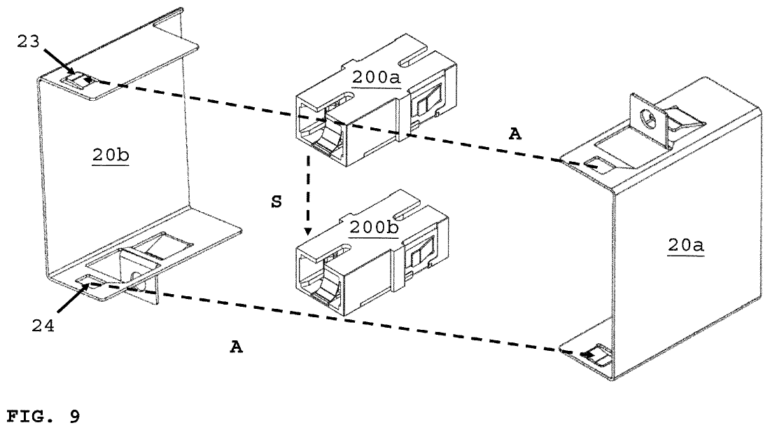

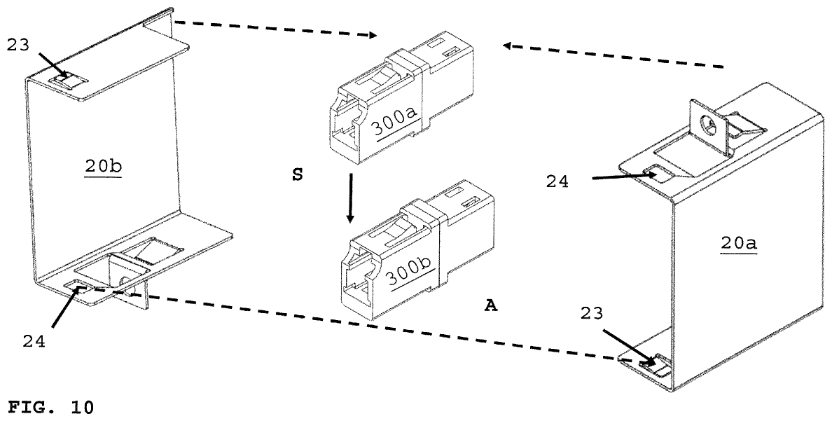

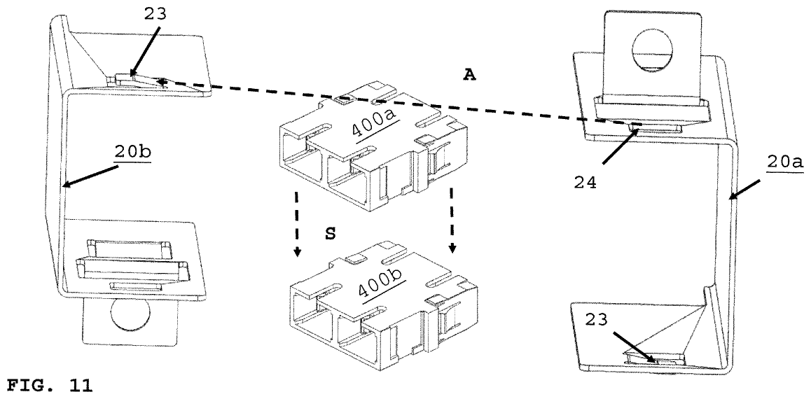

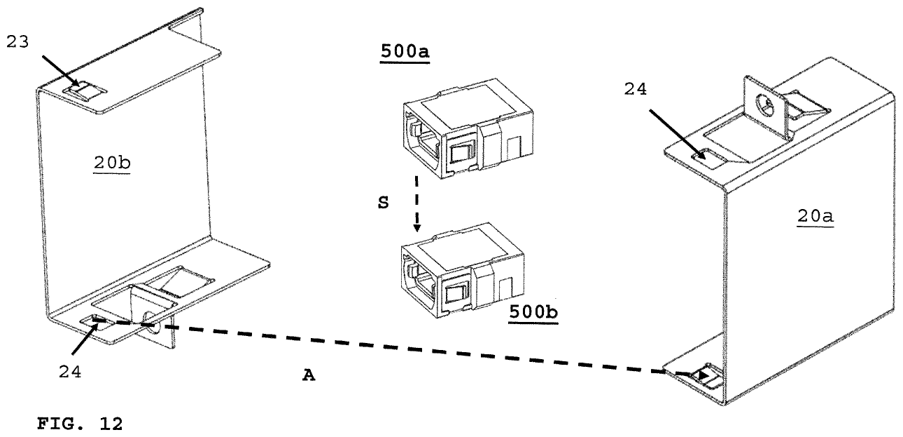

FIG. 8 depicts vertical stacking of first adapter (100a) and second adapter (100b) in direction of arrows “S”. Bifurcated housing is formed by assembling first body portion (20a) and second body portion (20b) in direction of arrows “A”. When the body portions are mated recess (23b) accepts securing clip (24a) and recess (23a) accepts securing clip (24b). This secures stacked adapters (100a, 100b) vertically. FIG. 9 depicts vertical stacking of SC adapter (200a, 200b) with a light shield. Opposing body portions (20a, 20b) are assembled in direction of the dotted lines to form the bifurcated housing to secure the stacked adapters. FIG. 10 depicts SC adapters (300a, 300b) or simplex, standard connector adapters vertically stack as in FIG. 9. Opposing body portion (20a, 20b) are assembled in direction of dotted lines to form the bifurcated housing. FIG. 11 depicts vertical stacking of duplex, SC adapters to form a quad SC adapter secured within the bifurcated housing formed by opposing body portions (20a, 20b). FIG. 12 depicts vertical stacking of MPO adapters (500a, 500b) in direction of arrow “S”, and secured within bifurcated housing formed by opposing body portions (20a, 20b).

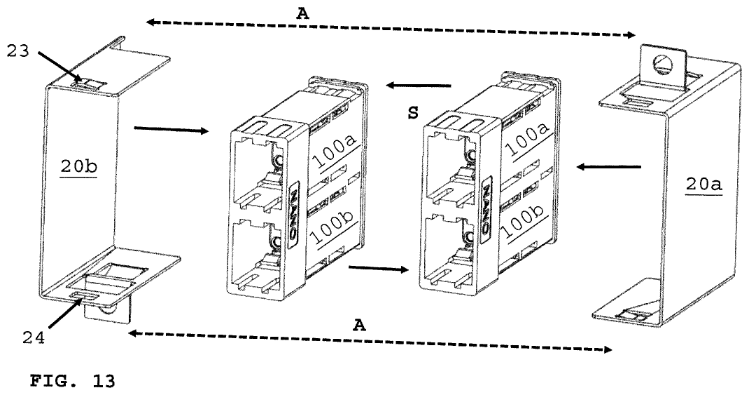

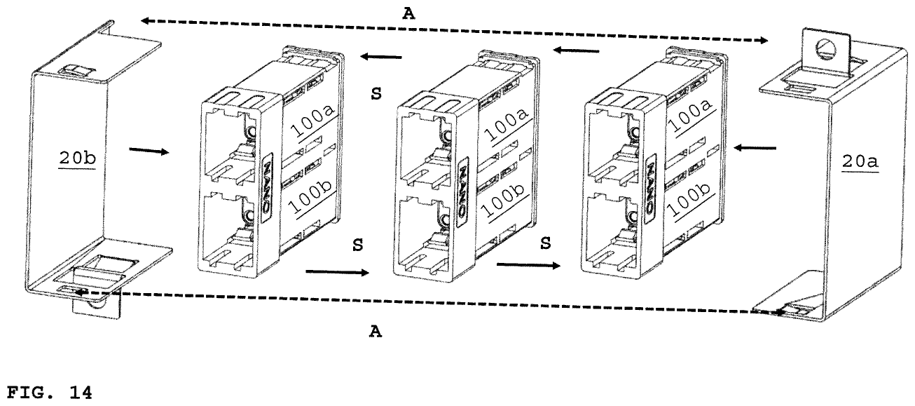

FIG. 13 depicts horizontal stacking of duplex port nano SN adapter (100a, 100b) in direction of arrow “S”. The set of adapters are secured within bifurcated housing formed by opposing body portions (20a, 20b). FIG. 14 depicts the horizontal stacking of three duplex port nano SN adapter (100a, 100b) in direction of arrow “S” and secured within bifurcated housing formed by opposing body portions (20a, 20b).

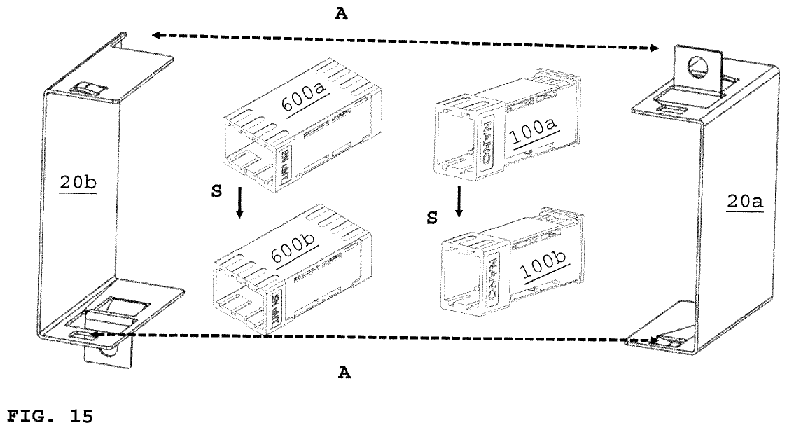

FIG. 15 depicts the vertical stacking of quad port nano adapters (600a, 600b) and the vertical stacking of duplex port nano adapters (100a, 100b) and the horizontal stacking of the vertical stack adapter sets. The stacked adapter sets are secured within bifurcated housing formed by opposing body portions (20a, 20b).

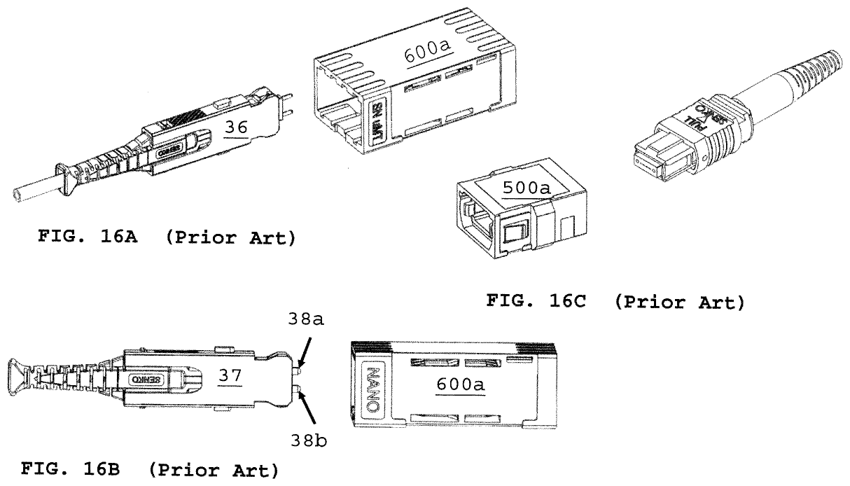

FIGS. 16A-16C depict prior art fiber optic connectors and adapters. Adapters (500a, 600a) are used with the present invention. Fiber optic connector (36) uses a mechanical transfer ferrule and fiber optic connector (37) deploys two opposing ferrules (28a, 38b). Both connectors (36, 37) can be use with adapter (600a).

Various embodiments of hybrid adapters disclosed herein may also be configured for use with other simplified connectors rather than micro connectors on one side. Also, in lieu of duplex LC adapters, embodiments may be configured for use with other standard size adapters, such as single LC adapters, on the opposite side.

One advantage of embodiments of adapters and connectors provided herein is reduction of the adapter size on the side that protrudes inside a module. Another advantage is inclusion of a ferrule spring to allow ferrule motions without the need for a full sized connector on the adapter side that, for example, protrudes inside a module. Specifically, embodiments provide an LC adapter having a smaller size inside a module, and providing a spring loaded motion for the optical fiber ferrule inside the module when the adapter is mated externally with a conventional LC connector. Thus, various embodiments require less space inside a module, as compared to conventional adapters, without sacrificing optical performance. Various parts, components or configurations described with respect to any one embodiment above may also be adapted to any others of the embodiments provided.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). The phrase “A or B” will be understood to include the possibilities of “A” or “B” or “A and B.

What is claimed:

1. A bifurcated outer housing for stacking two or more fiber optic adapters, comprising:
a first body portion;
a second body portion;
the first body portion and the second portion further comprise an outer housing wall and opposing sidewalls,
the opposing sidewalls are substantial perpendicular to the outer housing wall;
the first sidewall has a recess and a first panel clip and the second sidewall has a securing clip, and wherein the first sidewall recess is configured to accept a second body portion securing clip and the first sidewall securing clip is configured to accept second body portion recess to form the bifurcated housing.

2. The bifurcated outer housing for stacking two or more fiber optic adapters according to claim 1, wherein the first panel clip and a second panel clip are substantially opposed, and further wherein the first panel clip and the second panel clip secure the bifurcated housing within panel.

3. The bifurcated outer housing for stacking two or more fiber optic adapters according to claim 1, wherein the first body portion and the second body portion secure together one or more adapters horizontally.

4. The bifurcated outer housing for stacking two or more fiber optic adapters according to claim 1, wherein the first body portion and the second body portion secure together one or more adapters vertically.

5. The bifurcated outer housing for stacking two or more fiber optic adapters according to claim 3, wherein the first body portion and the second body portion further secure together one or more adapters vertically.

6. The bifurcated outer housing for stacking two or more fiber optic adapters according to claim 4, wherein the first body portion and the second body portion further secure together one or more adapters vertically.

7. The bifurcated outer housing for stacking two or more fiber optic adapters according to claim 5, wherein the adapters are selected from a group of adapters comprising a LC adapter, a MPO adapter, a SC adapter or a SN nano adapter.

8. The bifurcated outer housing for stacking two or more fiber optic adapters according to claim 6, wherein the adapters are selected from a group of adapters comprising a LC adapter, a MPO adapter, a SC adapter or a SN nano adapter.

9. The bifurcated outer housing for stacking two or more fiber optic adapters according to claim 7, wherein the adapters are configured to accept a fiber optic connector selected from a LC fiber optic connector, a MT fiber optic connector or a MPO fiber optic connector.

10. The bifurcated outer housing for stacking two or more fiber optic adapters according to claim 7, wherein the first adapter has a first port and the second adapter has a first port, and further wherein the first adapter port is configured to accept a first fiber optic connector and the second adapter first port is configured to accept a second fiber optic connector, and further wherein the first fiber optic connector is selected from a group of fiber optic connectors comprising a LC fiber optic connector, a MT fiber optic connector or a MPO fiber optic connector and the second fiber optic connector is selected from the group of fiber optic connectors comprising the LC fiber optic connector, the MT fiber optic connector or the MPO fiber optic connector

11. A bifurcated outer housing for stacking two or more fiber optic adapters resulting in the configuration of claim 1.

12. A method of assembling the bifurcated outer housing for stacking two or more fiber optic adapters, comprising:
providing a bifurcated housing according to claim 10;
securing a first adapter and a second adapter within the bifurcated housing, and
selecting the first adapter or the second adapter from a group of adapters comprising a LC adapter, SC adapter, a MPO adapter or a SN nano adapter.

13. A body portion, comprising:
an outer housing wall with opposing sidewalls,
the opposing sidewalls are generally perpendicular to the outer housing wall;
the first sidewall has recess nearer a first end and a panel clip distal of the recess;
a second sidewall opposes the first sidewall, and
the second sidewall has a securing clip at the first end.
